(19) United States
(12) Patent Application Publication
(10) Pub. No.: US 2023/0367365 A1
(43) Pub. Date: Nov. 16, 2023

(54) WEARABLE PRESSURE RELIEF STRUCTURE

(71) Applicant: OXTI Pte Ltd, Singapore (SG)

(72) Inventor: Chih-Feng Ho, Singapore (SG)

(21) Appl. No.: 17/744,748

(22) Filed: May 16, 2022

(51) Int. Cl. G06F 1/16; G06T 19/00

(52) U.S. Cl. CPC G06F 1/163; G06T 19/006

(57) ABSTRACT

A wearable pressure relief structure, including: a wearable body, one side thereof configured with an accommodating groove, and at least one side of the accommodating groove provided with an extending portion; and an elastic element, in combination with the accommodating groove. The wearable pressure relief structure of the present invention can be used together with a wearable device to support the wearable device with the wearable body, and use the elastic force of the elastic element to offset the weight of the wearable device, thereby solving the problem of burden on the body when the wearable device is worn for a long time, and getting a better use experience.

### (a) TECHNICAL FIELD OF THE INVENTION

The present invention relates to a pressure relief structure, and more particularly to a wearable pressure relief structure capable of being compatible with wearable devices to reduce the burden on the body caused by wearable devices.

### (b) DESCRIPTION OF THE PRIOR ART

The demand for head-mounted devices is increasing, ranging from frequently used headphones and glasses, surgical microscope glasses to VR and AR reality, which are very popular in recent years; life is full of all kinds of head-mounted devices. However, these head-mounted devices are easy to make the wearing area of the body feel uncomfortable due to weight compression after worn for a long time, which will reduce consumers' willingness to buy and use in a long-term base.

Taiwan Patent No. M621057, titled “headband adjustment mechanism and electronic device”, provides a head-mounted adjustable mechanism, at least including two headbands, a housing and adjustment knob, where the adjustment knob is used to tighten and loose the headband; the headband adjustment mechanism is suitable for wearing the headband. With its adjustment knob part for tightening and loosening the headband, it can reduce the burden and discomfort of long-term use.

However, the headband of the above headband adjustment mechanism has a narrower width, so it is easy to feel oppressed after wearing for a long time, and the functions and the compatible devices are limited.

### SUMMARY OF THE INVENTION

To overcome the disadvantages mentioned above, the present invention proposes a wearable pressure relief structure, including: a wearable body, one side thereof configured with an accommodating groove, and at least one side of the accommodating groove provided with an extending portion; and an elastic element, in combination with the accommodating groove,
where the elastic element is a detachable element, capable of being in combination with the accommodation groove of the wearable body in a detachable way;
where the elastic element is integrally formed with the accommodating groove of the wearable body;
where the elastic element is a foam pad, rubber pad, silicone pad or sponge pad; and
where there is a bending angle between the wearable body and extending portion.

The wearable pressure relief structure of the present invention can be used together with a wearable device to support the wearable device with the wearable body, and use the elastic force of the elastic element to offset the weight of the wearable device, thereby solving the problem of burden on the body when the wearable device is worn for a long time, and getting a better use experience.

### BRIEF DESCRIPTION OF THE DRAWINGS

FIG. 1 is a schematic view of the present invention integrally formed;

FIG. 2 is a schematic view of the present invention, where an elastic element is detachable;

FIG. 3 is a schematic view of the present invention applied to a headphone;

FIG. 4 is a schematic view of the present invention applied to smart glasses; and

FIG. 5 is a schematic view of the present invention, where the elastic element is used as a neck pillow.

### DETAILED DESCRIPTION OF THE PREFERRED EMBODIMENTS

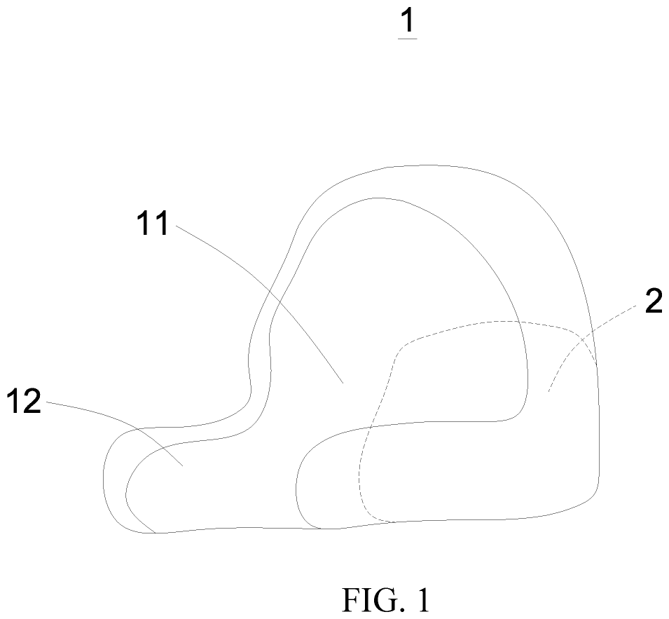

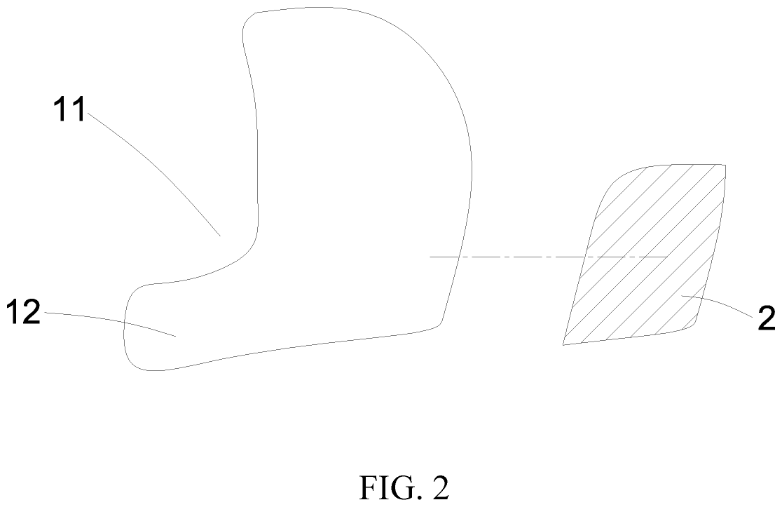

Referring to FIGS. 1 and 2, a wearable pressure relief structure of the present invention includes a wearable body 1 and elastic element 2.

The wearable body 1 may be made of soft material, and one side of the wearable body 1 is provided with an accommodating groove 11, at least one side of which is provided with an extending portion 12, where the accommodating groove 11 is used to accept a head and neck, and the elastic element 2 is placed inside any position of the accommodation groove 11, for example, corresponding to a position of the head or neck. In addition, a bending angle is formed between the wearable body 1 and extending portion 12, allowing the extending portion 12 to be bended relative to the wearable body 1.

The elastic element 2 may be a detachable element, in combination with the accommodating groove 11. The elastic element 2 may be a foam pad, rubber pad, silicone pad, or sponge pad, but not limited thereto. The size and thickness of the elastic element 2 can be determined according to actual needs, where the elastic element 2 may be in combination with the accommodating groove 11 of the wearable body 1 in a detachable way or in an integrable way.

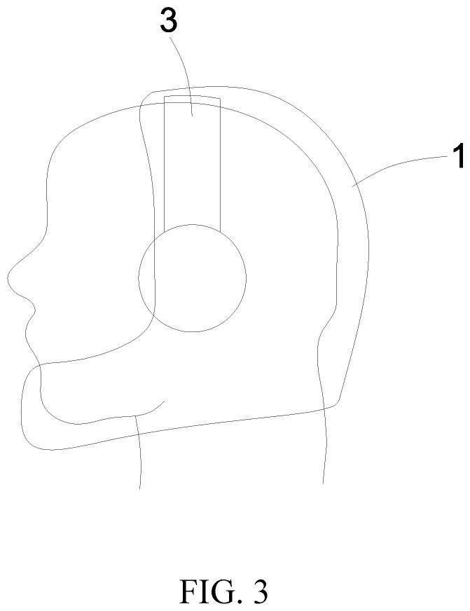

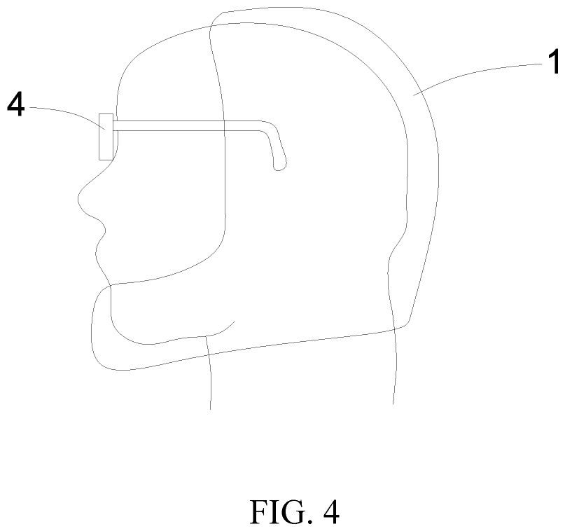

Referring to FIGS. 3 and 4, the wearable pressure relief structure of the present invention can be used together with a wearable device, which may for example be a headphone 3 as shown in FIG. 3, or smart glasses 4 as shown in FIG. 4, using the wearable body 1 to support the wearable device, and then using the elastic force of the elastic element 2 to approximately offset the weight of the wearable device, so as to lighten the load of the wearable device on the body.

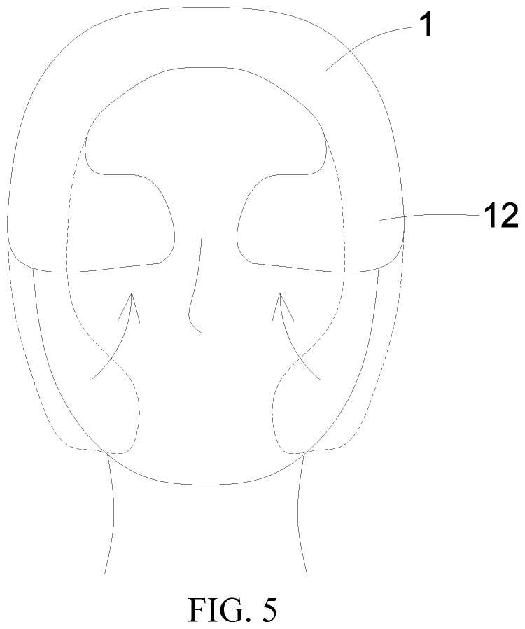

Referring to FIGS. 1 and 5, the wearable pressure relief structure also functions as a neck pillow, namely, the elastic element 2 is configured correspondingly to the neck, so that the wearable pressure relief structure is used to not only offset the weight of the wearable device but support the neck with the elastic element 2. Furthermore, the elastic element 2 is used to relieve the pressure on the neck due to shaking, and the extending portion 12 can further be bended relative to the wearable body 1, allowing the extending portion 12 to cover the eyes and be used as an eye mask.

The wearable pressure relief structure of the present invention can be used together with a wearable device to support the wearable device with the wearable body 1, and use the elastic force of the elastic element 2 to offset the weight of the wearable device, thereby solving the problem of burden on the body when the wearable device is worn for a long time, and getting a better use experience.

I claim:

1. A wearable pressure relief structure, comprising:
a wearable body, one side thereof configured with an accommodating groove, and at least one side of said accommodating groove provided with an extending portion; and
an elastic element, in combination with said accommodating groove.

2. The structure according to claim 1, wherein said elastic element is a detachable element.

3. The structure according to claim 1, wherein said elastic element is integrally formed with said accommodating groove of said wearable body.

4. The structure according to claim 1, wherein said elastic element is a foam pad, rubber pad, silicone pad or sponge pad.

5. The structure according to claim 1, wherein there is a bending angle between said wearable body and extending portion.
